(19) United States
(12) Patent Application Publication
(10) Pub. No.: US 2016/0046499 A1
(43) Pub. Date: Feb. 18, 2016

(54) APPARATUS AND METHOD FOR REDUCING CATALYST POISONING IN AN ANDRUSSOW PROCESS

(71) Applicants: INVISTA NORTH AMERICA S.A.R.L., Wilmington, DE (US); INVISTA TECHNOLOGIES S.A.R.L., St. Gallen (CH)

(72) Inventors: Stewart FORSYTH, Wilmington, DE (US); Aiguo LIU, Elk Grove, IL (US); Martin J. RENNER, Hallettsville, TX (US); Brent J. STAHLMAN, Victoria, TX (US)

(73) Assignee: INVISTA NORTH AMERICA S.A R.L., Wilmington, DE (US)

(21) Appl. No.: 14/741,927

(22) PCT Filed: Dec. 12, 2013
(86) PCT No.: PCT/US13/74726

§ 371 Date: Jun. 17, 2015

Related U.S. Application Data
(60) Provisional application No. 61/738,778, filed on Dec. 18, 2012.

(51) Int. Cl. C01C 3/02

(52) U.S. Cl. CPC C01C 3/0216

(57) ABSTRACT

Processes and systems for the production of hydrogen cyanide via the Andrussow process are described. A reaction zone, wherein oxygen, ammonia, and methane can be allowed to react in the presence of a catalyst comprising platinum to provide hydrogen cyanide. A desulfurization zone, wherein a feed stream comprising sulfur and at least one of the oxygen, the ammonia, and the methane can be contacted with a desulfurization material to produce a sulfur-reduced feed stream that is provided to the reaction zone. In an example, the desulfurization material includes zinc oxide.

### CROSS-REFERENCE TO RELATED APPLICATION

This application claims the benefit of priority to U.S. Provisional Patent Application Ser. No. 61/738,778 entitled “APPARATUS AND METHOD FOR REDUCING CATALYST POISONING IN AN ANDRUSSOW PROCESS,” filed Dec. 18, 2012, the disclosure of which is incorporated herein in its entirety by reference.

### TECHNICAL FIELD

The present disclosure is directed to a reactor scheme for the Andrussow process for the production of hydrogen cyanide (HCN) from methane, ammonia, and oxygen.

### BACKGROUND

The Andrussow process can be used for gas phase production of hydrogen cyanide (HCN) from methane, ammonia, and oxygen over a platinum catalyst. Filtered ammonia, natural gas, and air are fed into a reactor and heated to about 800° C. to about 2,500° C. in the presence of a catalyst that includes at least platinum. The methane can be supplied from natural gas, which can be further purified. Hydrocarbons having at least two carbons can be present in natural gas. Air can be used as a source of oxygen. Other oxygen-containing gas mixtures can also be used, including oxygen-enriched air having oxygen concentrations above about 21% (e.g., an oxygen Andrussow process), such as undiluted oxygen. The reactor off-gas containing HCN and un-reacted ammonia can be quenched in a waste heat boiler to approximately 100° C. to 400° C. The quenched reactor off-gas, containing HCN, can be sent through an ammonia absorption process to remove un-reacted ammonia, such as by contacting the reactor off-gas with ammonium phosphate solution, phosphoric acid, or sulfuric acid to remove the ammonia.

Feed stocks, including methane, ammonia, and oxygen, can include impurities, such as sulfur, which can poison an HCN catalyst. Poisoning of the HCN catalyst can decrease efficiency of the Andrussow process, such as reducing HCN conversion, increasing by-product production, decreasing lifetime of the HCN catalyst, increasing downtime for HCN catalyst replacement, or combinations thereof.

Various aspects of HCN production are described in the following articles: Eric. L. Crump, U.S. Environmental Protection Agency, Office of Air Quality Planning and Standards, Economic Impact Analysis For the Proposed Cyanide Manufacturing NESHAP (May 2000), available online at http://nepis.epa.gov/Exe/ZyPDF.cgi?Dockey=P100AHG1.PDF, is directed toward the manufacture, end uses, and economic impacts of HCN; N.V. Trusov, Effect of Sulfur Compounds and Higher Homologues of Methane on Hydrogen Cyanide Production by the Andrussow Method, Rus. J. of Applied Chemistry, Vol. 74, No. 10, pp. 1693-97 (2001), is directed toward the effects of unavoidable components of natural gas, such as sulfur and higher homologues of methane, on the production of HCN by the Andrussow process; Clean Development Mechanism (CDM) Executive Board, United Nations Framework Convention on Climate Change (UNFCCC), Clean Development Mechanism Project Design Document Form (CDM PDD), Ver. 3, (Jul. 28, 2006), available online at http://cdm.unfccc.int/Reference/PDDs_Forms/PDDs/PDD_form04_v03_{—}2. pdf, is directed toward the production of HCN by the Andrussow process; and Gary R. Maxwell et al., Assuring process safety in the transfer of hydrogen cyanide manufacturing technology, J. of Hazardous Materials, Vol. 142, pp. 677-84 (2007), is directed toward the safe production of HCN.

### SUMMARY

The present disclosure is directed to a solution to HCN catalyst poisoning by sulfur. The solution can include a system and method for mitigating catalyst poisoning in an Andrussow process by use of a guard bed between a gas feed and a reactor to remove sulfur. The present disclosure includes a system that utilizes a reaction zone wherein oxygen, ammonia, and methane are allowed to react in the presence of a catalyst comprising platinum to provide hydrogen cyanide. The system includes a desulfurization zone, in which a feed stream comprising sulfur and at least one of the oxygen, the ammonia, and the methane is contacted with a desulfurization material to produce a sulfur-reduced feed stream that is provided to the reaction zone.

The present disclosure also describes a system wherein the feed stream can comprise sulfur. The feed stream can comprise greater than about 0.2 parts per million by volume (ppm) of sulfur or less than about 17 ppm of sulfur. The produced sulfur-reduced feed stream can include less than about 0.2 ppm of sulfur or more than about 0.02 ppm of sulfur. The system can produce the sulfur-reduced feed stream such that it comprises at least 5% by weight less sulfur, 10% by weight less sulfur, or 20% by weight less sulfur than the feed stream.

The present disclosure also describes a feed stream that can comprise sulfur-containing compounds. Sulfur-containing materials can comprise sulfur compounds, sulfur-containing ions, sulfur-containing salts, sulfur-containing polymers, carbonyl sulfide, mercaptans, thiols, elemental sulfur, and mixtures thereof. The methane in the feed stream can be provided by a hydrocarbon mixture comprising natural gas, syngas, biogas, substantially pure methane, or mixtures thereof.

The desulfurization material of the present system can comprise zinc oxide. The desulfurization zone comprises a desulfurization unit upstream of the reaction zone. In the present description the desulfurization unit includes a packed bed reactor, in which the desulfurization catalyst is supported on a sloped screen in the desulfurization zone. The present system also includes a desulfurization zone within a hydrogen cyanide reactor of the reaction zone, such as a bed of desulfurization material in a packed bed of the hydrogen cyanide reactor. The desulfurization zone can include materials having greater corrosion resistance as compared to materials of the reaction zone. The reaction zone can include at least two hydrogen cyanide reactors operating in parallel, where each of the at least two hydrogen cyanide reactors receiving at least a portion of the sulfur-reduced feed stream.

The present disclosure also describes a process for producing hydrogen cyanide via the Andrussow process, comprising contacting a gas, including at least ammonia, a hydrocarbon, such as methane, and oxygen, and methane, with a desulfurization material to produce a sulfur reduced gas and contacting the sulfur reduced gas with a catalyst to produce at least hydrogen cyanide. The process can include heating the gas to at least about 100° C. prior to contacting with a desulfurization material. Further, the gas can be contacted with the desulfurization material at least at about 100° C. The presently described process can include reducing the sulfur in the sulfur reduced gas by about 5% by weight as compared to the gas. The process can also include splitting the sulfur reduced gas into at least two streams and feeding the at least two streams to a corresponding number of reactors operating in parallel.

These and other examples and features of the present systems and methods will be set forth in part in the following Detailed Description. This Summary is intended to provide an overview of the present subject matter, and is not intended to provide an exclusive or exhaustive explanation. The Detailed Description below is included to provide further information about the present systems and methods.

### BRIEF DESCRIPTION OF THE FIGURES

FIG. 1 is a schematic block flow diagram of an exemplary HCN production via the Andrussow process.

FIG. 2 is a schematic block flow diagram of a desulfurization HCN production via the Andrussow process according to the present disclosure.

### DETAILED DESCRIPTION

The synthesis of hydrogen cyanide by the Andrussow method (see, for example, Ullmann's Encyclopedia of Industrial Chemistry, Volume 8, VCH Verlagsgesellschaft, Weinheim, 1987, pp. 161-162) can be carried out in the vapor phase over a catalyst that comprises platinum or platinum alloys, or other metals. Catalysts suitable for carrying out the Andrussow process were discovered and described in the original Andrussow patent, published as U.S. Pat. No. 1,934,838, and elsewhere. In Andrussow's original work, he disclosed that catalysts can be chosen from oxidation catalysts that are infusible (solid) at the working temperature of around 1000° C.; he included platinum, iridium, rhodium, palladium, osmium, gold or silver as catalytically active metals either in pure form or as alloys. He also noted that certain base metals, such as rare earth metals, thorium, uranium, and others, could also be used, such as in the form of infusible oxides or phosphates, and that catalysts could either be formed into nets (screens), or deposited on thermally-resistant solid supports such as silica or alumina.

In subsequent development work, platinum-containing catalysts have been selected due to their efficacy and to the heat resistance of the metal even in gauze or net form. For example, a platinum-rhodium alloy can be used as the catalyst, which can be in the form of a metal gauze or screen such as a woven or knitted gauze sheet, or can be disposed on a support structure. In an example, the woven or knitted gauze sheet can form a mesh-like structure having a size from 20-80 mesh, e.g., having openings with a size from about 0.18 mm to about 0.85 mm. A catalyst can comprise from about 85 wt % to about 90 wt % Pt and from about 10 wt % to about 15 wt % Rh. A platinum-rhodium catalyst can also comprise small amounts of metal impurities, such as iron (Fe), palladium (Pd), iridium (Ir), ruthenium (Ru), and other metals. The impurity metals can be present in trace amounts, such as about 10 ppm or less.

A broad spectrum of possible embodiments of the Andrussow method is described in German Patent 549,055. In one example, a catalyst comprising a plurality of fine-mesh gauzes of Pt with 10 wt % rhodium disposed in series is used at temperatures of about 800 to 2,500° C., about 1,000 to 1,500° C., or about 980 to 1,050° C. For example, the catalyst can be a commercially-available catalyst, such as a Pt—Rh catalyst gauze available from Johnson Matthey Plc, London, UK, or a Pt—Rh catalyst gauze available from Heraeus Precious Metals GmbH & Co., Hanau, Germany.

Sulfur present in a feed stream, such as a methane stream, can poison HCN catalyst or damage processing equipment of an Andrussow system. For example, the sulfur content of a feed stream can reduce the efficiency of the HCN catalyst or negatively impact HCN conversion. This disclosure describes processes and systems for the production of hydrogen cyanide via the Andrussow process with a desulfurization unit, which can mitigate the negative impact sulfur can have on the system or process. In various examples, the processes and systems of the present disclosure can include a single reactor or multiple reactors. Due to the presence of impurities, such as sulfur or sulfur compounds, within a feed stream, catalyst poisoning within the hydrogen cyanide reaction zone can occur. The present inventors recognize that catalyst poisoning can be mitigated by implementation of a guard bed between the feed stream and the reactor to remove impurities such as sulfur. Additional capital costs realized from additional operating units, such as the guard bed, can be offset by a longer hydrogen cyanide catalyst life or a more consistent production rate of hydrogen cyanide, which in turn, can provide for more consistent operation of other parts of the Andrussow process (such as ammonia recovery, hydrogen cyanide purification, or wastewater treatment) and lower operation costs.

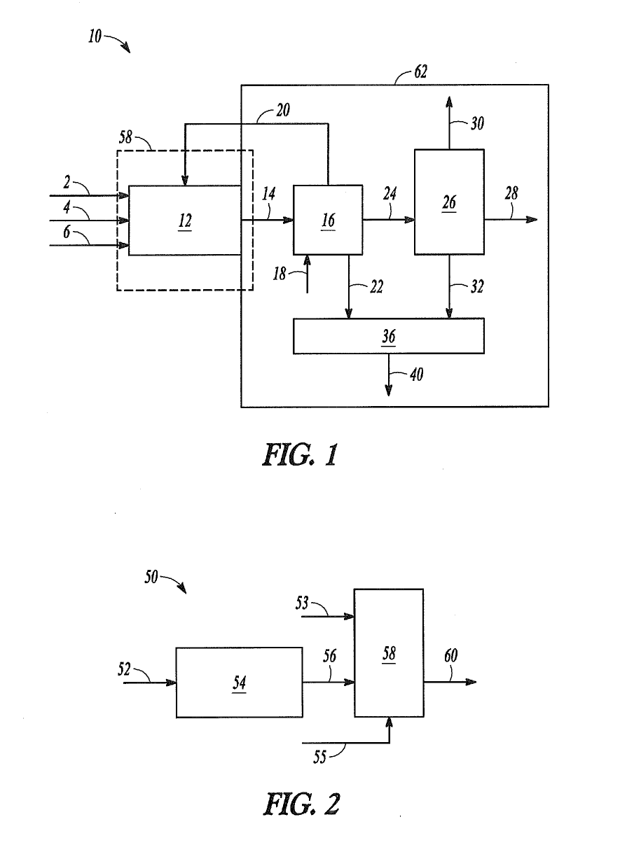

FIG. 1 is a flow diagram of an example process 10 for the production of hydrogen cyanide (HCN) via the Andrussow process. In the example process 10, a HCN synthesis system 12 is supplied with an ammonia (NH₃) stream 2, a methane (CH₄) stream 4, and an air stream 6 (which includes oxygen gas (O₂)). Air can include air and other oxygen-containing gas mixtures, including oxygen-enriched air having oxygen concentrations above about 21 vol %. The current process can operate under at least three process conditions, including Andrussow process conditions, air-enriched Andrussow process conditions, and oxygen Andrussow process conditions. The Andrussow process can include the air stream 6 with an oxygen concentration of about 21 vol %. The air-enriched Andrussow process can include the air stream 6 with an oxygen concentration greater than about 21 vol % and less than about 100 vol %. The oxygen Andrussow process can include an air stream 6 with an oxygen concentration of about 100 vol %. Typical Andrussow processes with a feed of 21 vol % oxygen concentration or higher are more susceptible to sulfur HCN catalyst poisoning than Andrussow processes with a feed stream less than 21 vol % oxygen. A poisoned HCN catalyst can increase reactant leakage through the HCN reactor, such as methane or ammonia. The present inventors recognize that higher levels of oxygen present in the reactor can reduce an amount of methane required for the reaction. Therefore, the present inventors propose the addition of a desulfurization unit upstream of the HCN catalyst to mitigate HCN catalyst poisoning in an Andrussow, air enriched Andrussow, or oxygen Andrussow process with a feed stream of at least 21 vol % oxygen.

The three feed streams 2, 4, 6, are mixed and reacted in one or more reactors to be converted to hydrogen cyanide and water in the presence of a suitable catalyst, according to Equation 1:

2NH₃+2CH₄+3O₂→2HCN+6H₂O [1]

The one or more reactors can be included in a reaction zone 58, as further described in relation to FIG. 2. The one or more reactors can include a HCN catalyst, such as platinum (Pt) or a platinum alloy, such as an alloy of platinum with rhodium (Rd) or palladium (Pd) containing at least about 85% platinum by weight, such as about 85 wt % to about 95 wt %, such as about 85 wt % Pt, 90 wt % Pt, or 95 wt % Pt. Alloys used in the Andrussow process can include, but are not limited to, 15 wt % Rh-85 wt % Pt, 10 wt % Rh-90 wt % Pt, 8 wt % Rh-92 wt % Pt, 5 wt % Rh-90 wt % Pt, or 5 wt % Rh-95 wt % Pt. Alloys containing up to about 5 wt % iridium (Ir) can be used. In an example, the HCN catalyst can be designed to reduce by products, such as nitrous-oxide by products, and therefore can have an increased rhodium (Rh) content, or other materials, such as cobalt (Co). The HCN catalyst can be contained in a packed bed, or be formed as gauze, such as by weaving or knitting metal filaments into gauze-like structures. Such formed catalysts can contain the catalytic materials described herein.

The HCN catalyst can be a commercially-available catalyst, such as a Pt—Rh catalyst gauze available from Johnson Matthey Plc, London, UK, or a Pt—Rh catalyst gauze available from Heraeus Precious Metals GmbH & Co., Hanau, GERMANY.

Further, increased levels of oxygen can have a damaging effect on the HCN catalyst life. For example, an HCN catalyst can have a life span of n days in an Andrussow process, a life span of about 0.8*n to about 0.9*n in an air enriched Andrussow process, or a life span of about 0.4*n to about 0.6*n in an oxygen Andrussow process. As such, the present inventors recognize that a desulfurization unit that removes sulfur, which also has a deleterious effect on the HCN catalyst, from the system 10 is important in maintaining an economical HCN production system.

The synthesized HCN can then be further processed in a post production zone 62. The resulting product stream 14 from the HCN synthesis system 12 can be fed into an ammonia recovery system 16 that is configured to recover unreacted NH₃. Ammonia can be recovered by NH₃ absorption via passage through one or more phosphoric acid (H₃PO₄), sulfuric acid (H₂SO₄), or an ammonium phosphate solution, that can absorb NH₃ from the product stream 14. In the example shown in FIG. 1, a phosphoric acid stream 18 is added to the ammonia recovery system 16 to absorb NH₃. Ammonia can be removed from the solution using one or more strippers to separate the NH₃ from the H₃PO₄. The NH₃ can be recycled back to the HCN synthesis system 12 via an NH₃ recycle stream 20. The H₃PO₄ and other waste can be purged as a wastewater stream 22, while an NH₃-stripped HCN stream 24 can be fed to an HCN recovery system 26. Ammonia recovery can be accomplished by a process or processes commonly known in the field.

The HCN recovery system 26 can include one or more unit operations configured to separate and purify HCN from the HCN stream 24. As a result of the HCN recovery system 26, a purified HCN product stream 28 is produced. The HCN recovery system 26 can also produce a waste gas 30 or a wastewater stream 32. Wastewater streams 22, 32 can be fed to waste water treatment 36 for further processing, such as recovery of ammonia or hydrogen cyanide. The final wastewater stream 40 from the waste water treatment 36 can be further processed, treated, or disposed.

FIG. 2 is a flow diagram of an example process 50 for the production of hydrogen cyanide (HCN) via the Andrussow process that implements a desulfurization zone 54. Feed stream 52 can include one or more feed streams 2, 4, 6, as shown in FIG. 1, such that feed stream 52 includes at least one of methane, ammonia, or oxygen, in combination with sulfur. In an example, the feed stream 52 is the methane feed stream. The methane can be provided by a stream of a hydrocarbon mixture, such as natural gas, syngas, biogas, substantially pure methane, or mixtures thereof. Syngas can include various mixtures of hydrogen (H₂) and carbon monoxide (CO) or any post-production process gas. The methane stream 4 can be in the form of a natural gas feed. The composition of the natural gas feed can be a majority CH₄ with small percentages of other hydrocarbons. In an example, the natural gas feed can be about 90 wt % to about 97 wt % CH₄, about 3 wt % to about 10 wt % ethane (C₂H₆), about 0 wt % to about 5 wt % propane (C₃H₈), about 0 wt % to about 1 wt % butane (C₄H₁₀, either in the form of isobutane, n-butane, or combinations thereof), and trace amounts of higher hydrocarbons and other gases. The natural gas feed can also be purified to comprise a more pure source of methane. In an example, a purified natural gas feed can comprise about 99.9% CH₄ and less than about 0.1 wt % other hydrocarbons (which are primarily ethane).

The feed stream 52 can also include sulfur from the hydrocarbon mixture. In an example, the sulfur content of the feed stream 52 can be greater than about 0.001 parts per million (ppm), 0.1 ppm, 0.2 ppm, or 0.4 ppm. The sulfur content of the feed stream 52 can be less than about 50 ppm, 30 ppm, 17 ppm, or 10 ppm. The sulfur can include any sulfur-containing compound, in gaseous or liquid form. Sulfur-containing materials can include materials, such as, sulfur-containing ions, sulfur-containing salts, sulfur-containing polymers, carbonyl sulfide, mercaptans, thiols, elemental sulfur, hydrogen sulfide, disulphates, thiophenes, sulfur oxides, or mixtures thereof. Sulfur can be poisonous for many HCN catalysts, for example Pt-based catalysts.

At least one feed stream 52 can be received by a desulfurization zone 54. The desulfurization zone 54 can permit the at least one feed stream 52, including at least methane, ammonia, or oxygen, in combination with sulfur, to contact a desulfurization material to produce a sulfur-reduced feed stream 56. In an example, the sulfur-reduced stream 56 can be combined with at least one additional gas stream 53, 55 comprising ammonia, methane, or oxygen. The sulfur-reduced stream 56 can be combined with the at least one additional gas stream 53, 55 in the reactor zone 58 but prior to a reactor, such that a reactor input gas stream, comprising ammonia, methane, and oxygen can enter the reactor. In an example, the sulfur-reduced gas stream 56 and the at least one additional gas stream 53, 55 can be combined with in a reactor in the reactor zone 58.

In an example, the desulfurization zone 54 can include a desulfurization unit upstream of a reaction zone 58. The desulfurization zone 54 can include any unit operation capable of contacting the feed stream 52 with a desulfurization unit, such as a packed bed unit, a hydrodesulfurization unit, or a pressure swing absorber. The desulfurization unit can include a number of configurations, including a vertical cylinder, a packed bed in the vertical cylinder oriented such that an amount of adsorbent in the packed is optimized, a flat packed bed that is comparatively easier to replace, a solid adsorbent, or a liquid adsorbent. In an example, the packed bed unit can include the desulfurization material (e.g., adsorbent), such as zinc oxide (ZnO), ferric oxide (FeO), alumina, copper-nickel (Cu—Ni) mixtures, or combinations thereof, in the form of a packed bed. In an example, the desulfurization material can vary based on the type of sulfur present in the feed stream. For example, ZnO can be used as the sole desulfurization agent when the sulfur present in the feed stream is primarily the form of inorganic compounds, such as sulfuric acid (H₂S). For example, zinc oxide absorbs H₂S according to Equation 2:

ZnO+H₂S→ZnS+H₂O+Heat [2]

The ZnO desulfurization material can include a commercially-available catalyst, such as ZnO pellets available from Gaoyi Sunpower Chemical Co., Ltd, of Hebei, China.

The presence of sulfur in the feed stream can reduce the life of the HCN catalyst. The desulfurization unit can provide the benefit of prolonging the effective lifespan of the HCN catalyst, reducing hazardous sulfur dioxide emissions, or mitigating the damage caused by a highly caustic sulfur-containing feed stream. For example, the HCN catalyst can, in the presence of lower sulfur conditions (e.g., less than about 0.2 ppm sulfur), have a lifetime of about 5 months to 6 months. However, higher sulfur conditions (e.g., greater than about 16 ppm) can reduce the HCN lifetime to a period of about 2 months to 4 months. Further, the lifetime of ZnO desulfurization material can be upwards of about 3 years. The reduction in amount of downtime associated with changing out the HCN catalyst, due to the increased lifetime, can increase productivity and, consequently, overall profitability of an HCN Andrussow system according to the present disclosure.

In an example, the packed bed can include a number of shaped units, for example, pellets, spheres, rings, cylinders, multi-holed extrudates and the like. The pellets and/or spheres can range in dimension of from about 1.5 to 20 mm, 3.0 to 15 mm, or 5.0 to 12 mm. The use of shaped units in a packed bed can provide the benefit of a high surface area for absorption or reaction with sulfur. Pressure drop, resulting from the resistance to gas flow through the bed, can be mitigated by a bed designed with a short path for the gas stream, such as about 5 to 200 mm, 10 to 100 mm, or 25 to 75 mm in thickness.

In an example, dimensions of the packed bed can be based on the composition of the feed stream, including sulfur content, a desired reduced sulfur stream composition, HCN production rate, HCN conversion rate, HCN catalyst type, environmental concerns, or any other process consideration. Dimensions of the packed bed can include a length, depth, density, width, particle size, particle shape, or the like.

In an example, it is desired to reduce the sulfur content of the feed stream such that benefits of a reduced sulfur stream are realized without adversely affecting the process. For example, desulfurization can adversely affect the HCN conversion rate by increasing by-products in the product stream. In an example, the feed stream can be desulfurized to produce a sulfur reduced stream 56 according to a desired HCN conversion rate. In an example, the desulfurization unit can produce the sulfur-reduced feed stream 56 such that it comprises at least 5% by weight less sulfur than the feed stream 52. However, unexpectedly, the present inventors discovered that the cost savings incurred due to a reduction in amount of downtime associated with changing out the HCN catalyst can substantially outweigh any costs associated with a reduction in the HCN conversion rate. Further, the present inventors discovered that the decrease in HCN conversion rate can be mitigated to reduce any negative cost implications.

In an example, the desulfurization zone 54 can include a pre-heater, such as a shell and tube, compact, air cooled, or combinations thereof, to heat the feed stream prior to a desulfurization unit. In an example, a shell and tube heat exchanger can use a process stream, such as steam, to heat the feed stream to at least about 50° C. to about 315° C., preferably to about 100° C. Heating the feed stream 52 can provide the benefit of increased desulfurization of the feed stream. In an example, the desulfurization zone 54 can include an adsorption desulfurization unit or a hydrogenating desulfurization unit, alone or in combination with the desulfurization unit.

In an example, the desulfurization zone 54 can include a desulfurization unit within the reaction zone 58, such as within a reactor. Such an example can provide the benefit of a reduced footprint of the system. After the HCN is synthesized in reaction zone 58, the HCN production stream 60 can be feed to a post production processing zone 62, as described above in relation to FIG. 1.

In an example, an Andrussow process can include contacting at least one gas, including at least ammonia, methane, and oxygen, with a desulfurization material to produce at least one sulfur reduced gas. For example, an ammonia stream, a methane stream, a stream including oxygen, or a combination thereof can contact a desulfurization material. The at least one desulfurized gas and optionally at least one additional gas stream comprising ammonia, methane, or oxygen, can be combined to form a reactor input gas stream, comprising ammonia, methane, and oxygen. The reactor input gas can contact a catalyst comprising platinum to produce at least hydrogen cyanide.

The at least one gas contacted with desulfurization material can include sulfur, such as at least about 0.02 ppm but less than about 17 ppm. The at least one gas can be heated prior to contacting the desulfurization material, such that the gas is contacted with the desulfurization material at least at about 100° C. The process can include reducing the sulfur in the at least one gas by about 5% by weight within the sulfur reduced gas as compared to the gas. The sulfur reduced gas can be split into multiple streams and feed to a corresponding number of HCN reactors operating in parallel.

In an example, the process can include reactivating the HCN catalyst, such as by replacing the HCN catalyst with fresh catalyst. The HCN catalyst can be replaced when a level of methane leakage is detected in stream 14, for example. In an example, the HCN catalyst can be changed when the product stream 14 comprises greater than about 0.2 vol % methane, 0.25 vol %, methane, 0.3 vol % methane, 0.35 vol % methane, 0.45 vol % methane, 0.55 vol % methane, 0.6 vol % methane, 0.65 vol % methane, 0.7 vol % methane, or 0.8 vol % methane. Benefits of the current process can include increasing the time between reactivating or replacing the HCN catalyst.

### EXAMPLES

The present disclosure can be better understood by reference to the following examples which are offered by way of illustration. The present disclosure is not limited to the examples given herein.

### Example 1

### Comparative Andrussow Process

This Example illustrates that an Andrussow process with a desulfurization unit can reduce sulfur content in a feed stream.

In an Andrussow manufacturing process, sulfuric acid (H₂S) present in a natural gas stream is removed by first heating the natural gas to 100° C. with a shell and tube exchanger using steam. The shell and tube exchanger is designed to heat natural gas from 25° C. to 100° C. with a flow of 3,100 pounds/hour steam to the shell. This system is optimized to remove H₂S at 100° C.

Two vessels in series include zinc oxide (ZnO) desulfurization pellets. The ZnO is supported on a sloped screen. Density of the catalyst is 65 pounds per cubic foot. At 100° C. the catalyst will absorb 5% by weight sulfur before exhaustion. Catalyst life of 3 years is anticipated at an average H₂S feed concentration of 2.0 ppm. However, a substantially longer life is expected since the H₂S concentration in the methane from the natural gas plant (NGP) unit is minimal. The reactors are valved out of service and the catalyst changed when treated gas leaving the lead reactor indicates greater than 0.5 ppm. A 4 inch internal diameter stainless steel reactor with ceramic insulation lining inside is used for pilot scale test. Forty sheets of 90 wt % Pt/10 wt % Rh 40 mesh gauze from Johnson Matthey (USA) are loaded as catalyst bed. Perforated alumina tile is used for catalyst sheet support. The total flow rate is set at 2532 SCFH (standard cubic foot per hour). In a simulated manufacturing sequence, three reactors are used in an oxygen Andrussow reaction facility to generate hydrogen cyanide from a reaction mixture of about 34 mol % methane, about 37 mol % ammonia, and about 27 mol % oxygen in the presence of the platinum catalyst. The gaseous product stream from each of the reactors contains about 17 mol % hydrogen cyanide, about 6 mol % unreacted ammonia, about 35 mol % hydrogen, about 6 mol % CO, and about 34 mol % H₂O, with an approximately 82% overall yield of hydrogen cyanide based on NH₃ reacted (mole based).

### Example 2

### Comparative Andrussow Process with Varying Oxygen Feed Concentrations

This Example illustrates that an Andrussow process that uses an enriched source of oxygen generally reduces HCN catalyst life span.

Hydrogen cyanide is produced via multiple Andrussow processes. One process, the air Andrussow process, employs air as the oxygen-containing gas, which includes 21 vol % oxygen. A second process, the air-enriched Andrussow process, employs an oxygen-containing gas having greater than about 21 vol % oxygen and less than about 100 vol % oxygen. A third process, the oxygen Andrussow process, employs an oxygen-containing gas that is about 100 vol % oxygen. A platinum-containing catalyst is used for all processes. A 4 inch internal diameter stainless steel reactor with ceramic insulation lining inside is used for pilot scale test. Forty sheets of 90 wt % Pt/10 wt % Rh 40 mesh gauze from Johnson Matthey (USA) are loaded as catalyst bed. Perforated alumina tile is used for catalyst sheet support. The total flow rate is set at 2532 SCFH (standard cubic foot per hour). In a simulated manufacturing sequence, three reactors are used in an Andrussow reaction facility to generate hydrogen cyanide in the presence of the platinum catalyst from a reaction mixture of about 34 mol % methane, about 37 mol % ammonia, and about 27 mol % oxygen for the oxygen Andrussow process, a reaction mixture of about 17 vol % CH₄, 19 vol % NH₄, and 64 vol % air for the air Androssow process, and a reaction mixture of about 25 vol % CH₄, 29 vol % NH₄, and 46 vol % oxygen-enriched air for the oxygen-enriched process. The gaseous product stream from the oxygen-Andrussow reactor contained about 17 mol % hydrogen cyanide, about 6 mol % unreacted ammonia, about 35 mol % hydrogen, about 6 mol % CO, and about 34 mol % H₂O, with an approximately 82% overall yield of hydrogen cyanide based on NH₃ reacted (mole based). The gaseous product stream from the air-Andrussow reactor contained about 76 mol % N₂, about 4 mol % HCN, about 1.5 mol % unreacted ammonia, about 8 mol % hydrogen, about 1.5 mol % CO, and about 8 mol % H₂O, with about 4% overall yield of HCN based on NH₃ reacted. The gaseous product stream from the oxygen-enriched air-Andrussow reactor contains about 55 mol % N₂, about 9 mol % HCN, about 2 mol % unreacted ammonia, about 12 mol % hydrogen, about 2 mol % CO, and about 20 mol % H₂O, with about 60% overall yield of HCN based on NH₃ reacted.

Ammonia is separately removed from each of the product streams in a process involving absorption into an ammonium phosphate stream. Hydrogen cyanide is then removed from the ammonia-depleted product stream in a process involving acidified water, thereby separately generating a hydrogen cyanide product and a gaseous waste stream for each of the processes.

The life span of the HCN catalyst from the air, air enriched, and oxygen processes are shown below in Table 1.

TABLE 1

| Process | HCN Catalyst Life Span Factor |
|---|---|
| Air Andrussow | 1.0 |
| Air Enriched Andrussow | 0.8-0.9 |
| Oxygen Andrussow | 0.4-0.6 |

As illustrated, an Andrussow process that employs an enriched oxygen stream as a source of the oxygen reactant reduces the lifespan of the HCN Catalyst. Consequently, reducing the amount of sulfur poisoning experienced by the HCN catalyst in an air enriched or oxygen Andrussow process is critical.

The above Detailed Description is intended to be illustrative, and not restrictive. For example, the above-described examples (or one or more elements thereof) can be used in combination with each other. Other examples can be used, such as by one of ordinary skill in the art upon reviewing the above description. Also, various features or elements can be grouped together to streamline the disclosure. This should not be interpreted as intending that an unclaimed disclosed feature is essential to any claim. Rather, inventive subject matter can lie in less than all features of a particular disclosed example. Thus, the following claims are hereby incorporated into the Detailed Description, with each claim standing on its own as a separate example. The scope of the invention should be determined with reference to the appended claims, along with the full scope of equivalents to which such claims are entitled.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented, at least in part. Some examples can include a computer-readable medium or machine-readable medium encoded with instructions operable to configure an electronic device to perform methods or method steps as described in the above examples. An implementation of such methods or method steps can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The Abstract is provided to comply with 37 C.F.R. §1.72(b), to allow the reader to quickly ascertain the nature of the technical disclosure. It is submitted with the understanding that it will not be used to interpret or limit the scope or meaning of the claims.

Although the invention has been described with reference to exemplary examples, workers skilled in the art will recognize that changes may be made in form and detail without departing from the spirit and scope of the invention.

The invention has been described broadly and generically herein. Each of the narrower species and subgeneric groupings falling within the generic disclosure also form part of the invention. This includes the generic description of the invention with a proviso or negative limitation removing any subject matter from the genus, regardless of whether or not the excised material is specifically recited herein. In addition, where features or aspects of the invention are described in terms of Markush groups, those skilled in the art will recognize that the invention is also thereby described in terms of any individual member or subgroup of members of the Markush group.

The following statements of the invention describe some of the elements or features of the invention. Because this application is a provisional application, these statements may become changed upon preparation and filing of a nonprovisional application. Such changes are not intended to affect the scope of equivalents according to the claims issuing from the nonprovisional application, if such changes occur. According to 35 U.S.C. §111(b), claims are not required for a provisional application. Consequently, the statements of the invention cannot be interpreted to be claims pursuant to 35 U.S.C. §112.

### STATEMENTS OF THE INVENTION

1. A system for producing hydrogen cyanide via the Andrussow process, comprising:

a reaction zone wherein oxygen, ammonia, and methane are allowed to react in the presence of a catalyst comprising platinum to provide hydrogen cyanide;
a desulfurization zone, wherein a feed stream comprising the oxygen, the ammonia, and the methane is contacted with a desulfurization material to produce a sulfur-reduced feed stream that is provided to the reaction zone.

2. The system of statement 1, wherein the feed stream comprises sulfur.

3. The system of statement 1 or 2, wherein the feed stream comprises greater than about 0.05 ppm, 0.1, ppm, 0.2 ppm, 0.5 ppm, or 1.0 ppm of sulfur.

4. The system of any one of statements 1-3, wherein the feed stream comprises less than about 17 ppm of sulfur.

5. The system of any one of statements 1-4, wherein the sulfur-reduced feed stream comprises less than about 17 ppm, 10 ppm, 5 ppm, 1.0 ppm, 0.5 ppm, 0.2 ppm, or 0.1 ppm of sulfur.

6. The system of any one of statements 1-5, wherein the sulfur-reduced feed stream comprises more than about 0.02 ppm of sulfur.

7. The system of any one of statements 1-6, wherein the sulfur-reduced feed stream comprises at least 1%, at least 2%, at least 5%, at least 10%, or at least 20% by weight less sulfur than the feed stream.

8. The system of any one of statements 2-7, wherein the sulfur is provided by sulfur-containing materials.

9. The system of statement 8, wherein the sulfur-containing materials are in gaseous or liquid form.

10. The system of any one of statements 8-9, wherein the sulfur-containing materials comprise sulfur compounds, sulfur-containing ions, sulfur-containing salts, sulfur-containing polymers, carbonyl sulfide, mercaptans, thiols, elemental sulfur, and mixtures thereof.

11. The system of any one of statements 1-10, wherein the methane is provided by a hydrocarbon mixture.

12. The system of statement 11, wherein the hydrocarbon mixture comprises natural gas, syngas, biogas, substantially pure methane, or mixtures thereof.

13. The system of any one of statements 1-12, wherein the desulfurization material comprises zinc oxide, molybdenum disulfide, ruthenium disulfide, combinations of cobalt and molybdenum, copper-nickel, ferric oxide, activated alumina, or combinations thereof.

14. The system of any one of statements 1-13, wherein the desulfurization zone comprises a stand-alone desulfurization unit upstream of the reaction zone.

15. The system of statement 14, wherein the desulfurization unit comprises a packed bed reactor.

16. The system of statement 15, wherein the desulfurization catalyst is supported on a sloped screen in the desulfurization zone.

17. The system of any one of statements 1-16, wherein the desulfurization zone comprises a bed within a hydrogen cyanide reactor of the reaction zone.

18. The system of any one of statements 1-17, wherein the reaction zone comprises at least two hydrogen cyanide reactors operating in parallel, each of the at least two hydrogen cyanide reactors receiving at least a portion of the sulfur-reduced feed stream.

19. The system of any one of statements 1-18, wherein the desulfurization zone comprises materials having greater corrosion resistance as compared to materials of the reaction zone.

20. The system of any one of statements 1-19, wherein the oxygen is supplied from an air enriched stream.

21. The system of statement 20, wherein the air enriched stream comprises greater than about 21 vol % oxygen.

22. A process for producing hydrogen cyanide via the Andrussow process, comprising:

contacting at least one gas, comprising at least ammonia, methane, and oxygen, with a desulfurization material to produce at least one sulfur reduced gas;

combining the at least one desulfurized gas and optionally at least one additional gas stream comprising ammonia, methane, or oxygen, to form a reactor input gas stream, comprising ammonia, methane, and oxygen; and

contacting the reactor input gas stream with a catalyst comprising platinum to produce at least hydrogen cyanide.

23. The process of statement 22, wherein the at least one gas comprises sulfur.

24. The process of statements 22 or 23, comprising heating the gas to at least about 100° C. prior to contacting with the desulfurization material.

25. The process of any one of statements 22-24, wherein the gas is contacted with the desulfurization material at least at about 100° C.

26. The process of any one of statements 22-25, wherein contacting the gas with the desulfurization material reduces sulfur by about 5% by weight within the sulfur reduced gas as compared to the gas.

27. The process of any one of statements 22-26, comprising:

splitting the sulfur reduced gas into at least two streams; and

feeding the at least two streams to a corresponding number of reactors operating in parallel.

28. The process of any one of statements 22-27, further comprising contacting an air enriched stream comprising at least about 21 vol % oxygen with the catalyst.

29. The process of statement 28, wherein the air enriched stream is the at least one additional gas stream.

30. The system or process of any one or any combination of statements 1-29 is optionally configured such that all elements or options recited are available to use or select from.

1-21. (canceled)

22. A process for producing hydrogen cyanide via the Andrussow process, comprising:
contacting at least one gas, comprising at least one of ammonia, methane, and oxygen, with a desulfurization material to produce at least one sulfur reduced gas;
combining the at least one desulfurized gas and optionally at least one additional gas stream comprising ammonia, methane, or oxygen, to form a reactor input gas stream, comprising ammonia, methane, and oxygen; and
contacting the reactor input gas stream with a catalyst comprising platinum to produce at least hydrogen cyanide.

23. The process of claim 22, wherein the at least one gas comprises sulfur.

24. The process of claim 22, comprising heating the gas to at least about 100° C. prior to contacting with the desulfurization material.

25. The process of claim 22, wherein the gas is contacted with the desulfurization material at least at about 100° C.

26. The process of claim 22, wherein contacting the gas with the desulfurization material reduces sulfur by about 5% by weight within the sulfur reduced gas as compared to the gas.

27. The process of claim 22, comprising:
splitting the sulfur reduced gas into at least two streams; and
feeding the at least two streams to a corresponding number of reactors operating in parallel.

28. The process of claim 22, further comprising contacting an air enriched stream comprising at least about 21 vol % oxygen with the catalyst.

29. The process of claim 28, wherein the air enriched stream is the at least one additional gas stream.
